(19) United States
(12) Patent Application Publication
(10) Pub. No.: US 2003/0066165 A1
(43) Pub. Date: Apr. 10, 2003

(54) Hinge

(75) Inventors: William S. Hansen II, Mettawa, IL (US); Charles E. Bullock, Waukegan, IL (US)

Correspondence Address: William A. Webb, Brinks Hofer Gilson & Lione, P.O. Box 10395, Chicago, IL, 60610, US

(73) Assignee: A.L Hansen Mfg. Co.

(21) Appl. No.: 09/973,137

(22) Filed: Oct. 9, 2001

(51) Int. Cl. E05D 7/10

(52) U.S. Cl. 16/266

(57) ABSTRACT

A hinge includes first and second leaves The first hinge leaf includes a hook having a hook opening that faces generally toward a mounting surface. The second hinge leaf includes an integral pin that is rotatably positioned within the hook, and the second hinge leaf defines a recess sized to receive the first hinge leaf when the hinge is closed. The mounting surface obstructs the opening in the hook, thereby preventing the pin from moving out of the hook when the hinge is mounted in place. The hook is preferably shaped to receive the pin in a snap fit to hold the two hinge leaves together prior to the time the hinge is mounted in place.

### BACKGROUND

The present invention relates to hinges of the type used to secure a panel (e.g. a door panel) to an adjacent element (e.g. a door frame).

Hinges generally include two hinge leaves interconnected by one or more hinge pins. Erickson U.S. Pat. No. 3,952,369, Bentley U.S. Pat. No. 4,123,822, and MacKirdy U.S. Pat. No. 4,688,305 can be taken as examples. However, in spite of this earlier work, a need presently exists for an improved hinge that can be efficiently fabricated and installed, and that provides improved security.

### SUMMARY

By way of general introduction, the hinge described below includes a first hinge leaf that defines a hook, and the hook includes an opening that faces an adjacent mounting surface. The hinge also includes a second hinge leaf that includes a one piece, integral hinge pin that is received in the hook. In the illustrated example, the first hinge leaf is configured such that, when secured in place adjacent to a mounting surface, the mounting surface itself prevents the hinge pin from moving out of the hook. In this illustrated example, the second hinge leaf includes a recess that substantially entirely receives the first hinge leaf when the second hinge leaf is rotated to a closed position. This approach improves the aesthetic appearance of the closed hinge, as well as its security. In particular, the closed hinge completely masks the hinge pin from pry bars and the like.

This summary has been provided by way of general introduction, and it should not be used to narrow the scope of the following claims.

### BRIEF DESCRIPTION OF THE DRAWINGS

FIG. 1 is a perspective view of a hinge that incorporates a preferred embodiment of this invention.

FIG. 2 is a perspective view of a first hinge leaf included in the hinge of FIG. 1.

FIG. 3 is a bottom view of the hinge leaf of FIG. 2.

FIG. 4 is a side view of the hinge leaf of FIG. 2.

FIG. 5 is a cross-sectional view taken along line 5-5 of FIG. 3.

FIG. 6 is a perspective view of a second hinge leaf included in the hinge of FIG. 1.

FIG. 7 is a top view of the hinge leaf of FIG. 6.

FIG. 8 is a cross-sectional view taken along line 8-8 of FIG. 7.

FIG. 9 is a bottom view of the hinge leaf of FIG. 6.

FIG. 10 is an end view taken along line 10-10 of FIG. 8.

FIG. 11 is a cross-sectional view of the hinge of FIG. 1 in a closed position.

FIG. 12 is a cross-sectional view of the hinge of FIG. 1 in a partially opened position.

### DETAILED DESCRIPTION OF THE DRAWINGS

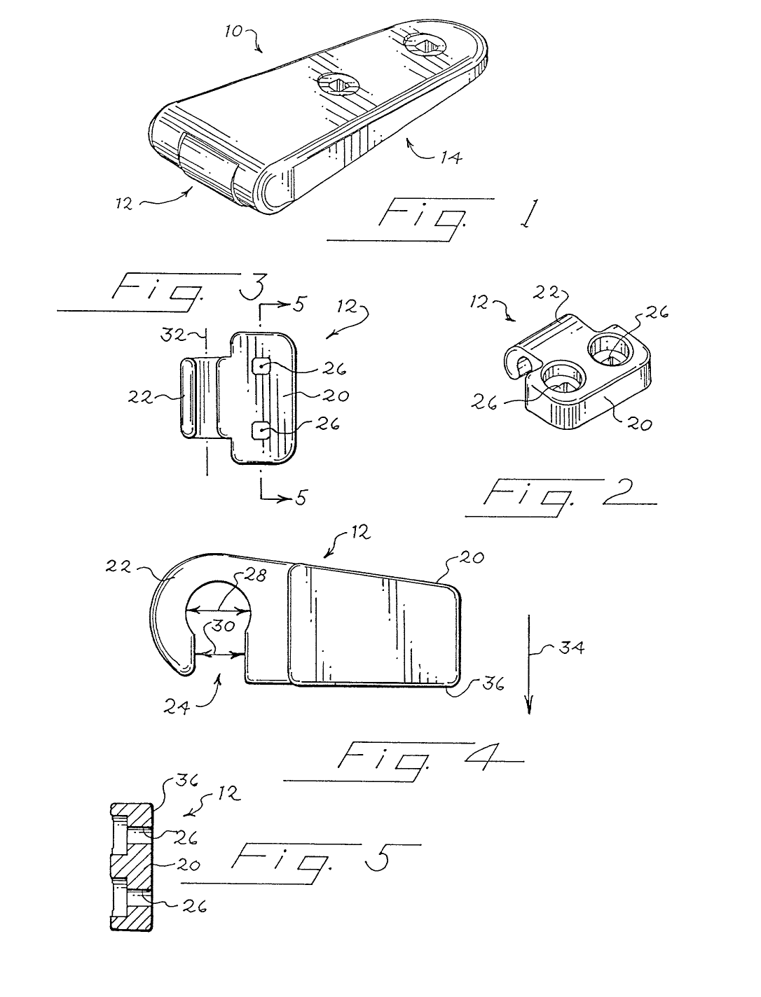

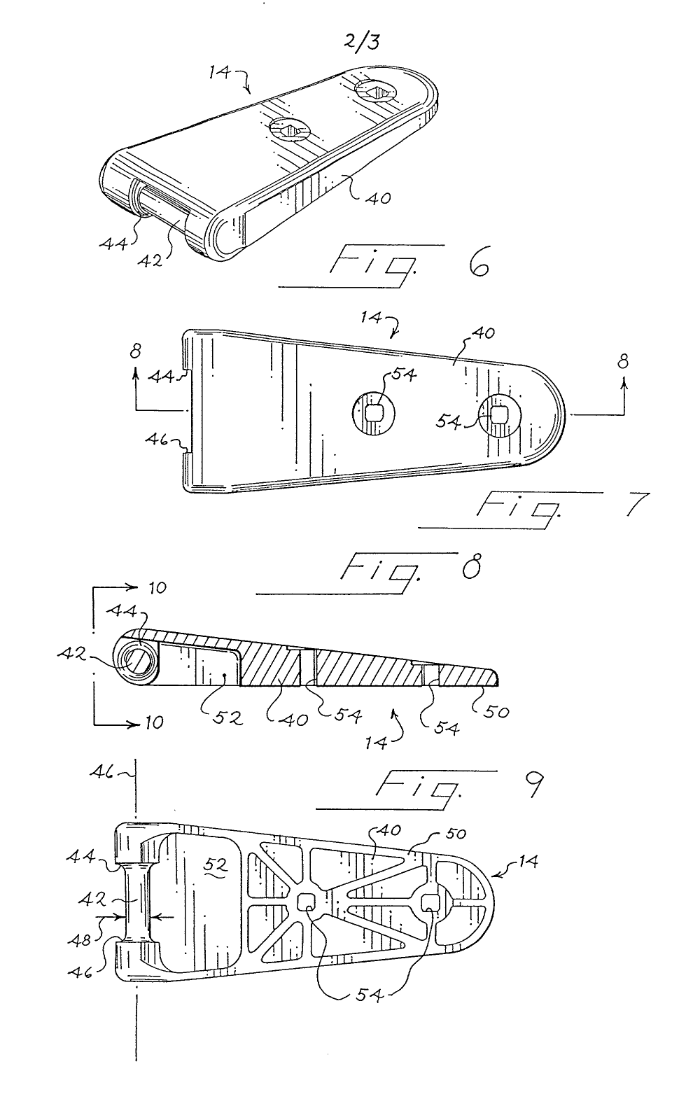

Turning now to the drawings, FIG. 1 shows a perspective view of a hinge 10 that incorporates a preferred embodiment of this invention. The hinge 10 includes a first hinge leaf 12 (as shown in greater detail in FIGS. 2-5) and a second hinge leaf 14 (as shown in greater detail in FIGS. 6-10).

As shown in FIGS. 2-5, the first hinge leaf 12 includes a hinge body 20 that defines a hook 22. The hook 22 forms an opening 24 (FIG. 4), and the body 20 forms fastener openings 26. As best shown in FIG. 4, the hook 22 defines an internal diameter 28, and an opening width 30. In this example, the opening width 30 is smaller than the hook internal diameter 28. The center of the hook 22 coincides with an axis of rotation 32 (FIG. 3). The body 20 also defines a lower surface 36, and both the lower surface 36 and the opening 24 face in a first direction 34 (downwardly in the view of FIG. 4).

The first hinge leaf 12 is preferably formed in one piece from a molded thermoplastic polymer such as nylon (e.g. 33% glass-filled nylon). Conventional ultraviolet inhibitors can be used to make the first hinge leaf 12 more durable.

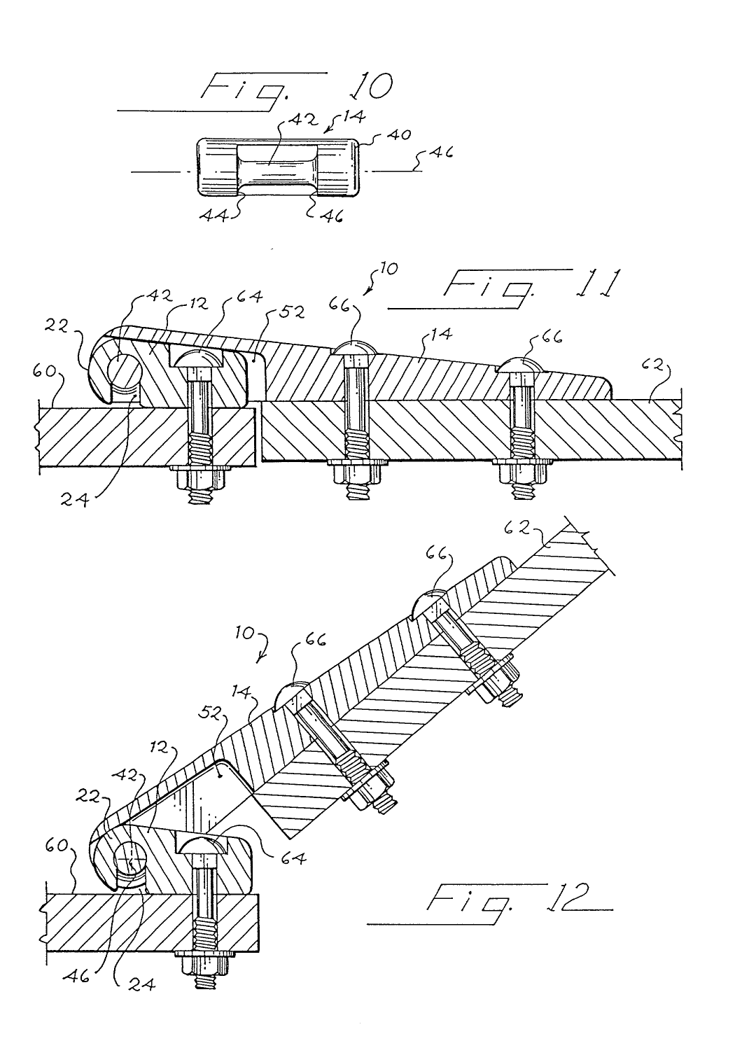

As shown in FIGS. 6-10, the second hinge leaf 14 includes a body 40 that in turn includes an integral pin 42. The pin 42 functions as a hinge pin in the hinge, as described below. The body 40 also defines two facing shoulders 44, 46, and the pin 42 extends completely across the distance between the shoulders 44, 46 in a continuous, uninterrupted manner (FIG. 9). In this example, the pin 42 is generally cylindrical in shape and is centered on a pin axis 46. The pin 42 defines a pin diameter 48 that in this example is larger than the opening width 30 but somewhat smaller than the hook internal diameter 28 described above in conjunction with FIG. 4.

The body 40 also defines a lower surface 50 that defines a recess 52 (FIGS. 8-9). In this example, the recess 52 is sized to receive the body 20 of FIG. 2, as shown and described below. In this example, the second lower surface 50 extends around three sides of the recess 52, and the second lower surface 50 extends farther from the pin 42 than does the first lower surface 36, when the first and second hinge leaves 12, 14 are assembled as shown in FIGS. 11-12. The body 40 also defines two fastener openings 54.

In this example, the second hinge leaf 14 is molded from a thermoplastic polymer, which may be the same polymer as that used for the first hinge leaf 12. In this example the body 40, the pin 42, and the shoulders 44, 46 are all integrally molded in one piece. This simplifies fabrication.

Prior to mounting the hinge 10 in place, the first and second hinge leaves 12, 14 are assembled by snap locking the pin 42 within the hook 22. As explained above, the diameter of the pin 42 is somewhat larger than the opening width 30 of the opening 24, and the hook 22 must be resiliently deformed to insert the pin 42 into the hook 22. Once the pin 42 is in place within the hook 22, the hook 22 relaxes to its initial state, thereby snap locking the pin 42 in place.

FIGS. 11 and 12 show the hinge 10 mounted to a mounting surface 60 and an adjacent door panel 62. In this example, the mounting surface 60 is included in a door frame, and first fasteners 64 secure the first hinge leaf 12 in place against the mounting surface 60. The second hinge leaf 14 is mounted to the door panel 62 by second fasteners 66.

FIG. 11 shows the hinge 10 in a closed position, in which the first hinge leaf 12 is substantially entirely received within the recess 52 of the second hinge leaf 14. Note that in this position the first fasteners 64 are hidden by the body 40, as is the pin 42. This provides an attractive appearance to the closed hinge 10, and it protects the pin 42 from unauthorized removal efforts.

FIG. 12 shows the hinge 10 in a partly opened position, in which the second hinge leaf 14 has been rotated about the pin axis 46 with respect to the first hinge leaf 12. Note that in both the closed position of FIG. 11 and the partially opened position FIG. 12, the mounting surface 60 obstructs the opening 24 in the hook 22, thereby preventing movement of the pin 42 out of the hook 22. The fasteners 64 that secure the first hinge leaf 12 in place adjacent the mounting surface 60 simultaneously retain the pin 42 in place in the hook 22.

The hinge 10 described above provides a number of important advantages as follows:

1. The hinge 10 is readily assembled prior to mounting in place, because the hook snap fits over the integral pin;

2. Because the pin is an integral part of the associated hinge leaf, the hinge cannot be sabotaged by driving the pin out of the hinge leaf to separate the two hinge leaves;

3. Because the direction of the snap-fit opening on the hook is toward the mounting surface, the pin cannot be moved out of the hook by prying it upwardly;

4. Only two components are required to create the hinge, and thereby the cost of a separate hinge pin is eliminated;

5. Because the hinge leaves are made of thermoplastic polymer, the snap fit described above is readily achieved. Furthermore, thermoplastic polymers can be self-lubricating, thereby providing a smoother hinge action as compared to metal-on-metal contact.

Of course, many changes and modifications can be made to the preferred embodiment described above. For example, the hinge leaves may be formed of other materials including metals, and in this case the hook can be deformed to hold the hinge pin in place (in substitution for the snap fit described above).

Furthermore, the size and shape of the hinge can be varied widely as appropriate for particular applications, as can the number and position of the mounting openings. In one alternative form of the invention, the first hinge leaf does not fit within a recess in the second hinge leaf, but rather the first hinge leaf extends away from the second hinge leaf when the hinge is in the closed position. In another alternative, the first hinge leaf can be mounted in place on the mounting surface by fasteners that extend parallel to the mounting surface, rather than at right angles to the mounting surface as shown in FIGS. 11-12.

In this example, the hook internal diameter 28, the opening width 30, and the pin diameter 48 are measured transversely to the pin axis 46.

As used herein, the term “lower surface” is intended broadly, and it may include perforated surfaces such as the surface 50 described above.

The term “integral pin” is intended to convey that the pin is rigidly secured to the associated hinge leaf such that it cannot be removed by driving it out of the hinge leaf along the pin axis.

The term “mounting surface” is used to refer to the surface of the mounting structure that is positioned opposite the hook opening. The mounting surface may include other surfaces, transverse to the surface opposite the hook opening.

The term “deformed” is intended broadly to encompass elastic deformation.

The foregoing detailed description has discussed only a few of the many forms that this invention can take. For this reason, this detailed description is intended by way of illustration, and not by way of limitation. It is only the following claims, including all equivalents, that are intended to define the scope of this invention.

1. A hinge comprising:
a first hinge leaf comprising a first lower surface that faces in a first direction and a hook, said hook comprising an opening that faces generally in the first direction;
a second hinge leaf comprising an integral pin rotatably positioned within the hook, a recess sized to receive the first hinge leaf, and a second lower surface that extends farther from the pin than does the first lower surface;
said first hinge leaf secured to a mounting surface with the first lower surface and the opening facing the mounting surface, said mounting surface obstructing the opening, thereby preventing the pin from moving out of the hook

2. The hinge of claim 1 wherein the second lower surface extends around the three sides of the recess.

3. The hinge of claim 1 wherein the hook is shaped to receive the pin in a snap-lock fit, such that the hook retains the pin in the hook prior to securing the first hinge leaf to the mounting surface.

4. The hinge of claim 3 wherein the first hinge leaf comprises a thermoplastic polymer, and the hook must be deformed to remove the pin from the hook.

5. The hinge of claim 1 wherein the second hinge leaf comprises two facing shoulders, and wherein the pin extends completely between the two facing shoulders.

6. The hinge of claim 5 wherein the hook is received between the two facing shoulders.

7. The hinge of claim 6 wherein the pin comprises a pin axis and a pin diameter measured transverse to the pin axis, wherein the opening comprises an opening width measured transverse to the pin axis, and wherein the pin diameter is larger than the opening width.

8. A hinge comprising:
a first hinge leaf comprising a hook, said hook comprising an opening that faces in a first direction;
a second hinge leaf comprising an integral pin rotatably positioned within the hook;
said first hinge leaf secured to a mounting surface with the opening facing the mounting surface, said mounting surface obstructing the opening, thereby preventing the pin from moving out of the hook;
said hook shaped to receive the pin in a snap-lock fit, such that the hook retains the pin in the hook prior to securing the first hinge leaf to the mounting surface.

9. The hinge of claim 8 wherein the first hinge leaf comprises a thermoplastic polymer, and the hook must be deformed to remove the pin from the hook.

10. The hinge of claim 8 wherein the second hinge leaf comprises two facing shoulders, and wherein the pin extends completely between the two facing shoulders.

11. The hinge of claim 10 wherein the hook is received between the two facing shoulders.

12. The hinge of claim 11 wherein the pin comprises a pin axis and a pin diameter measured transverse to the pin axis, wherein the opening comprises an opening width measured transverse to the pin axis, and wherein the pin diameter is larger than the opening width.
